(19) United States
(12) Patent Application Publication
(10) Pub. No.: US 2025/0232689 A1
(43) Pub. Date: Jul. 17, 2025

(54) READING ENGINE(S) FOR ADAPTIVE NARRATIVES

(71) Applicant: Microsoft Technology Licensing, LLC, Redmond, WA (US)

(72) Inventors: Adam Michael KELLY, Vancouver (CA); Alexander William DARROW, Seattle, WA (US); Hannah WILKINSON, Ottawa (CA); Hyunsun Heidi KIM, Cresskill, NJ (US); Kristofer Ken Perez CASTRO, Coquitlam (CA); William Kenneth FRY, Issaquah, WA (US); Michelle WANTUCH, Seattle, WA (US); Anuradha Narayan PADTE, Seattle, WA (US); Paul Ronald RAY, Kirkland, WA (US); Alistair Robert KILPATRICK, Lightwater (GB); Shay BEN-ELAZAR, Herzliya (IL); Ella BEN TOV, Tel Aviv (IL); Merav MOFAZ, Tel Aviv (IL); Yossef Hai BEN DAVID, Tel Aviv (IL)

(21) Appl. No.: 18/622,346

(22) Filed: Mar. 29, 2024

Related U.S. Application Data
(60) Provisional application No. 63/621,868, filed on Jan. 17, 2024.

(51) Int. Cl. G09B 17/00; G09B 5/02

(52) U.S. Cl. CPC G09B 17/003; G09B 5/02

(57) ABSTRACT

Systems and methods for providing a reading engine for enhanced and adaptive narratives are provided herein. In an example, a system may include instructions to receive, from a first client device, an indication to start a narrative and generate, by a reading engine, a first chapter of the narrative based on the first client device. The reading engine may generate the first chapter to include a first set of challenge words. The reading engine monitors a reading of the first chapter by the first client device and determines one or more low fluency words based on the reading by the first client device. The reading engine may also provide narrative options for continuing the narrative present in the first chapter. Responsive to receiving a selection of a first narrative option the reading engine may generate a second chapter of the narrative based on the first narrative option.

### CROSS REFERENCE TO RELATED APPLICATION

This application is related to and claims priority to U.S. Provisional Patent Application No. 63/621,868 filed Jan. 17, 2024 entitled “READING ENGINE(S) FOR ADAPTIVE NARRATIVES,” the contents of which is incorporated by reference in its entirety for all purposes.

### TECHNICAL FIELD

Aspects of the disclosure are related to the field of computer software applications and services and, in particular, to reading engines for providing adaptive and enhanced reading exercises within educational environments.

### BACKGROUND

The importance of learning to read for young students cannot be overstated, as it serves as a fundamental gateway to academic success and lifelong learning. Reading proficiency is the key that unlocks a vast treasure trove of knowledge across various subjects, enabling students to comprehend textbooks, engage with literature, and access information independently. Beyond academics, literacy is a foundational skill essential for effective communication in everyday life. As students progress in their education, the ability to read critically becomes crucial for analyzing information, solving problems, and making informed decisions. Moreover, reading fosters cognitive development, enhances vocabulary, and cultivates a rich imagination. Early exposure to literature also nurtures empathy by allowing students to explore diverse perspectives and cultures through the written word. Ultimately, learning to read empowers young minds, opening doors to a world of possibilities and shaping them into well-rounded, informed individuals ready to contribute meaningfully to society.

Conventional methods of teaching students to read, however, contain multiple shortcomings. One prominent issue lies in the one-size-fits-all approach, which may not adequately address the diverse learning styles and individual needs of students. The reliance on rote memorization and repetitive drills, common in traditional phonics-based instruction, can be monotonous and fail to engage students effectively. Additionally, conventional methods may struggle to accommodate the varied backgrounds and language abilities of a diverse student population. The emphasis on isolated phonetic rules may oversimplify the complexity of the English language, especially for learners who speak English as a second language. Furthermore, the limited incorporation of technology and interactive learning tools in traditional approaches may miss opportunities to leverage multimedia resources that can enhance engagement and comprehension. Overcoming these challenges requires a shift towards more personalized, interactive, and inclusive teaching methodologies that cater to the individualized needs of students, fostering a more effective and enjoyable learning experience.

Another issue that arises from conventional teaching methods is lack of engagement. The lack of engagement with reading exercises can have a profound negative impact on students learning how to read. When students are disinterested or unmotivated to engage with reading materials, the learning process becomes hindered. Reading is not merely a mechanical task of decoding words but a cognitive activity that requires active participation and comprehension. If students fail to connect with the content, they may struggle to grasp the context, meaning, and nuances of the written text. Moreover, a lack of engagement can impede the development of crucial literacy skills such as fluency, vocabulary acquisition, and critical thinking. When students view reading as a chore rather than an enjoyable exploration, they are less likely to invest the time and effort needed to develop their reading abilities. This disengagement can perpetuate a cycle where students fall behind in their literacy development, impacting not only their academic achievements but also limiting their ability to derive pleasure and knowledge from the vast world of literature. Addressing this issue necessitates creating a learning environment that fosters a love for reading, encourages active participation, and aligns reading materials with students' interests and developmental levels.

As such, there is a need for a reading engine, and its related functions, for enhanced and adaptive reading exercises that generate reading exercises tailored to each individual student's reading needs. That is, there is a need for more personalized and adaptive approaches when it comes to teaching students how to read, including tailoring reading exercises to individual students to provide a more engaging and effective learning experience.

### SUMMARY

Technology disclosed herein includes software applications and services that provide a reading engine, and its related functions, for providing enhanced and adaptive reading exercises within educational scenarios. In particular, an example reading engine is provided herein that facilitates a more dynamic and individualized approach for teaching reading and expanding vocabulary for students. To tailor reading exercises to an individual student, the reading engine evaluates a student's learning preferences and needs and incorporates them into an adaptive narrative. For example, the reading engine evaluates words that the student grapples with in earlier exercises and surfaces these challenge words in subsequent chapters or exercises. The reading engine also identifies related words that other students find similarly testing to a given student's challenge words and incorporates those related words into the student's reading exercises. In this manner, the reading engine tailors reading exercises to an individual student's learning pace and weaknesses to provide an inclusive educational environment.

The reading engine uses an adaptive narrative to foster student engagement with the reading exercise. When students are emotionally or intellectually engaged with a story, they are more likely to invest cognitive effort needed for comprehension and retention of the subject material. As such, enhanced engagement with the narrative of a reading exercise aids in development of reading skills. To nurture engagement with a narrative of a reading exercise, the reading engine prompts students to decide how the narrative should unfold. In other words, the reading engine provides a “choose your own adventure” style narrative in which each student gets to decide what happens at the end of each chapter. By providing the student with control over the narrative, the reading engine enhances the student's investment in the narrative, thereby improving the student's cognitive and emotional ties to the story.

From the educator's perspective, the reading engine provides vital insight into reading progress for individual students, as well as a class as a whole. The reading engine evaluates how students perform on a reading exercise, such as how accurate the exercise was performed, and provides a summary to a respective educator. By providing educators with insights into how students are performing on exercises, the reading engine allows educators to understand how material is received by students and what materials need to be revisited in future lessons. In other words, the reading engine provides educators with information needed to tailor an overall class or curriculum to the needs of each individual classroom, thereby providing an enhanced learning environment.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a reading engine for enhanced exercises, according to an embodiment herein;

FIG. 2 illustrates a brief operational scenario to further highlight an application of the reading engine, according to an embodiment provided herein;

FIG. 3 illustrates a system for providing a reading engine and related functions, according to an embodiment herein;

FIG. 4 illustrates a process for providing the reading engine and its related functions, according to an embodiment herein;

FIG. 5 illustrates an example prompt for generating a narrative using the reading engine, according to an embodiment herein;

FIG. 6 illustrates an example narrative generated by a reading engine, according to an embodiment herein;

FIG. 7 illustrates an example first chapter of a narrative, according to an embodiment herein;

FIG. 8 illustrates an example second chapter of the narrative provided in FIG. 7, according to an embodiment herein;

FIG. 9 illustrates a graphical user interface (GUI) for providing a reading engine, according to an embodiment herein;

FIG. 10 provides a GUI illustrating metrics by student within a class for a reading exercise, according to an embodiment herein;

FIG. 11 provides a GUI illustrating a submitted exercise view, according to an embodiment herein; and

FIG. 12 shows an example client device suitable for providing a reading engine and related functions, according to an embodiment herein.

### DETAILED DESCRIPTION

The importance of learning how to read cannot be overstated, acting as a crucial pathway to both academic achievement and lifelong learning. Proficiency in reading acts as the key that unlocks a vast reservoir of knowledge spanning various subjects, enabling students to comprehend textbooks, engage with literature, and independently access information. Beyond academic pursuits, literacy emerges as a foundational skill crucial for effective communication in everyday life. As students advance in their education, the ability to read critically becomes essential for analyzing information, solving problems, and making informed decisions. Furthermore, reading contributes to cognitive development, enriches vocabulary, and nurtures a vibrant imagination. Early exposure to literature also promotes empathy by allowing students to explore diverse perspectives and cultures through written expressions. Ultimately, the acquisition of reading skills empowers young minds, opening doors to a realm of possibilities and shaping them into well-rounded, informed individuals prepared to contribute meaningfully to society.

Pronunciation is intricately tied to reading, as mastering the accurate sounds and intonations of words is essential for developing strong phonemic awareness, a foundational skill that underpins fluent and effective reading. Thus, learning how to correctly pronounce words is a vital step in mastering how to read. Beyond reading, learning how to pronounce words is a fundamental aspect of effective communication and language mastery. Accurate pronunciation is a cornerstone of clear and intelligible speech, facilitating meaningful interactions in both academic and social contexts. Proficient pronunciation not only aids comprehension but also enhances one's ability to convey thoughts, ideas, and emotions with precision. In educational settings, proper pronunciation is integral to successful language acquisition and literacy development. It lays the groundwork for proficient reading and writing skills, contributing to overall language proficiency. Additionally, in a globalized world, where communication spans diverse linguistic backgrounds, mastering pronunciation fosters cross-cultural understanding and promotes effective communication across borders. Therefore, the significance of learning how to pronounce words lies in its pivotal role in fostering confident, articulate, and culturally aware communicators.

Current teaching methods for reading and word pronunciation, however, exhibit several shortcomings that impede the holistic development of students' language skills. Traditional approaches often rely on rigid, one-size-fits-all methodologies that may not cater to the diverse learning styles and individual needs of students. The emphasis on rote memorization and repetitive drills in phonics-based instruction can be monotonous and fail to capture the attention or engagement of learners. Furthermore, some methods may neglect the importance of context and real-world application, hindering students' ability to connect reading skills with practical communication. Additionally, the focus on pronunciation often lacks cultural sensitivity, neglecting the diverse linguistic backgrounds students may bring into the classroom.

Additionally, current reading teaching methods often fall short in effectively engaging students, leading to disinterest and diminished learning outcomes. Many traditional approaches rely heavily on repetitive drills and standardized materials, lacking the dynamism needed to capture the attention of diverse learners. The one-size-fits-all nature of these methods disregards the individualized needs and varied learning styles of students, contributing to a lack of personal connection with the material. A lack of engagement with a narrative can significantly impede a student's ability to learn how to read by diminishing their interest in the material. When students fail to connect emotionally or intellectually with the story, they are less likely to invest the cognitive effort needed for comprehension and retention, hindering the development of essential reading skills such as fluency and critical analysis.

Additionally, the absence of real-world relevance and interactive elements in reading instruction may fail to spark curiosity or make learning enjoyable. As technology continues to advance, there is a growing disconnect between conventional teaching methods and the digital age, resulting in missed opportunities to leverage multimedia resources that could enhance student engagement. To foster a love for reading, it is crucial for educators to embrace more interactive, culturally relevant, and technology-integrated strategies that cater to the diverse interests and learning preferences of students, ultimately making the learning experience more captivating and meaningful.

To address these shortcomings, an example reading engine, and its related functions, is provided herein to provide a more dynamic, inclusive, and personalized teaching platform. The reading engine evaluates individual learning preferences and incorporates them into an adaptive narrative that fosters a deeper engagement and understanding of both reading and pronunciation within meaningful contexts. For example, the reading engine observes a student's reading of a given narrative and evaluates the reading in terms of pronunciation and accuracy. The reading engine identifies words that the student may find challenging, such as low fluency (e.g., mispronounced, omitted) words and incorporates the challenge words into a follow-up narrative. The reading engine also identifies related challenge words and incorporates those into follow-up narratives. In this manner, the reading engine monitors a student's grasp on reading and word pronunciation and tailors reading exercises to the student's current comprehension and level.

Additionally, the reading engine enhances engagement and comprehension with the reading material by providing an interactive and adaptive narrative. To engage students with a given narrative, the reading engine allows students to select how the story proceeds at the end of each chapter. That is, after a first chapter is completed, the reading engine prompts the student to select between two or more narrative options that set how the narrative will proceed in the following chapter. By letting students choose their own storylines, the reading engine enhances student engagement with the narrative, thereby increasing student's focus and duration of reading. Overall, the reading engine provides a personalized, interactive, and inclusive teaching platform that caters to the individualized needs of students, fostering a more effective and enjoyable learning experience, which in turn increases student comprehension and engagement.

Moreover, the reading engine provides educators with information on how students grasp various narratives and challenge words. That is, the reading engine can track how well each student performs on reading exercises including various challenge words and provides a summary to the educator. Such a summary can provide the educator with vital information on how material is received by students and provide insight on what concepts and challenge words should be the focus of future lessons.

Furthermore, the reading engine leverages content generators, such as large language models (LLMs), for generation of enhanced reading exercises. For example, the reading engine observes a student's reading of the first chapter of a narrative and identifies challenge words that the student struggles with during the reading. Upon completion of the first chapter, the reading engine prompts the student with options on how the narrative should continue. The student's selection on how the narrative should continue and the challenge words are used by a content generator within the reading engine, along with the narrative present in the first chapter, to generate a second chapter. The second chapter is coherent with the first chapter and continues the storyline along the option selected by the student. To provide additional visual cues for the student, the reading engine may also generate an illustration using a content generator to match a general theme of a generated chapter, and in some cases, to include one or more challenge words.

Overall, the reading engine, and related functionality, provided herein not only improves the educational environment by providing enhanced reading exercises tailored to students' individualized needs, but it also provides educators with vital information required to adapt their teaching approach to the students' pace, knowledge, and specific challenges. The reading engine helps build a deeper conceptual understanding of reading principles and words, promotes critical thinking skills, and instills confidence in students as they navigate the intricacies of the subject. By fostering students' knowledge and appreciation for reading, the reading engine aids students with gaining essential problem-solving and linguistic skills that are applicable in various real-world scenarios. Overall, the individualized teaching approach provided by the reading engine and the subsequent acquisition of reading and pronunciation skills contribute not only to academic success but also to the development of practical, transferable skills crucial for lifelong learning and success.

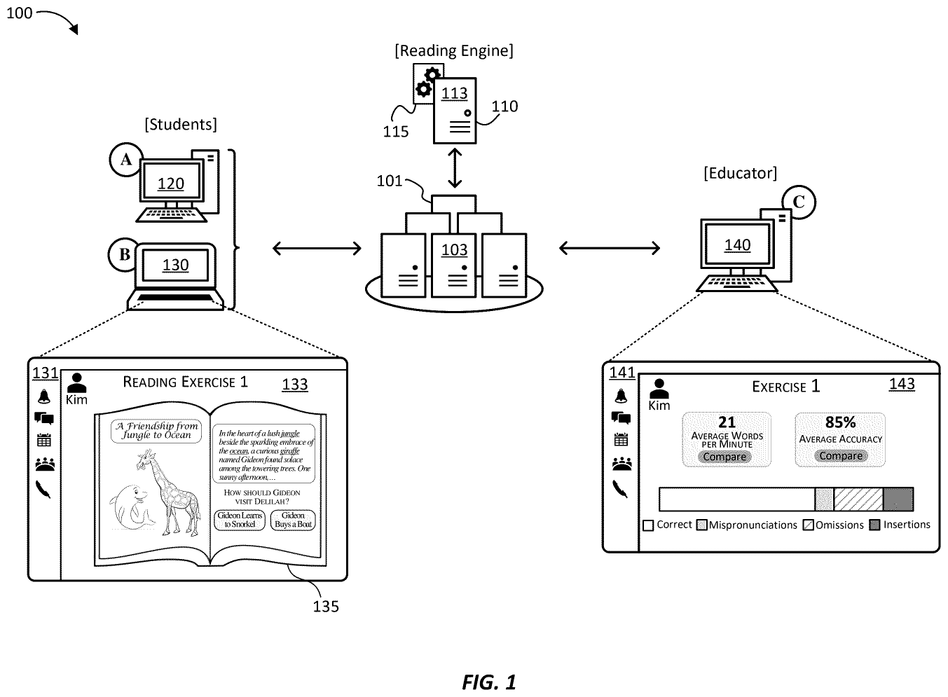

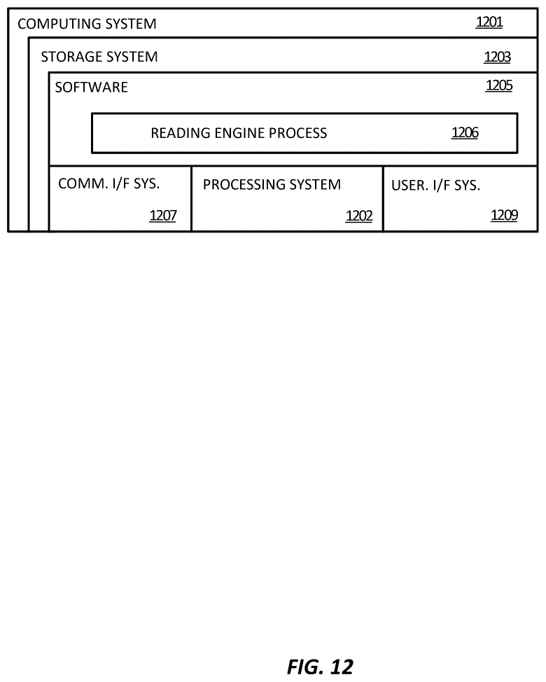

Turning now to FIG. 1, FIG. 1 illustrates an operational environment 100 for providing a reading engine for enhanced exercises, according to an embodiment herein. As illustrated, the operational environment 100 includes an application service 101, a reading engine 110, and client devices 120, 130 and 140. The application service 101 employs one or more server computers 103 co-located with respect to each other or distributed across one or more data centers. Example servers include web servers, application servers, virtual or physical servers, or any combination or variation thereof, of which computing system 1201 in FIG. 12 is broadly representative.

The client devices 120, 130, and 140 communicate with application service 101 via one or more internets and intranets, the Internet, wired and wireless networks, local area networks (LANs), wide area networks (WANs), or any other type of network or combination thereof. Examples of the client devices 120, 130, and 140 may include personal computers, tablet computers, mobile phones, gaming consoles, wearable devices, Internet of Things (IoT) devices, and any other suitable devices, of which computing system 1201 in FIG. 12 is also broadly representative.

Broadly speaking, the application service 101 provides software application services to end points, such as the client devices 120, 130, and 140, examples of which include productivity software for creating content (e.g., word processing, spreadsheets, and presentations), email software, and collaboration software. The client devices 120, 130, and 140 load and execute software applications locally that interface with services and resources provided by the application service 101. The applications may be natively installed and executed applications, web-based applications that execute in the context of a local browser application, mobile applications, streaming applications, or any other suitable type of application. Example services and resources provided by the application service 101 include front-end servers, application servers, content storage services, authorization and authentication services, and the like.

The application service 101 also includes an integration with the reading engine 110, which is capable of generating adaptive narratives, analyzing students' reading of a given narrative, and reporting on a student's progress. The reading engine 110 may include one or more functions that allow the reading engine 110 to generate adaptive narratives tailored to a student's needs, monitor a student's reading of the adaptive narrative, and generate a summary of the student's reading accuracy and progress based on the student's interactions via the application service 101. For example, the application service 101 may provide a reading exercise application through which the reading engine 110 provides one or more of its functions.

To provide these functions, the reading engine 110 employs one or more server computers 113 co-located with respect to each other or distributed across one or more data centers, of which computing system 1201 in FIG. 12 is broadly representative. In some embodiments, the reading engine 110 hosts a content generator 115 on server computers 113 as well. In other embodiments, the content generator 115 may be hosted separately from the reading engine 110, such as by a third party. As will be described in greater detail below, the reading engine 110 may provide a student's selection on a narrative option (e.g., how the storyline should continue) and identified challenge words from a preceding chapter to the content generator 115 for generation of a subsequent chapter.

The application service 101 hosts or provides an application, such as a reading exercise application, through which users of the client devices 120 and 130, user A and user B, respectively, can practice their reading skills. For example, the application service 101 may provide or host an educational application through which exercises are prepared by an educator, such as the user of the client device 140 (user C). Users A and B may be students in the illustrated example. As such, users A and B may perform and complete one or more reading exercises provided by the application service 101 via a corresponding reading exercise application.

To generate a narrative for a given reading exercise, the reading engine 110 may gather user-based information for a respective student. For example, the reading engine 110 may gather user-based information, such as from past reading exercises, corresponding to challenge words that user B struggles with. As can be appreciated, struggling with words or having issues pronouncing various words relates to a student's ability to understand a respective narrative and can impact advancement of the student's linguistic skills. Additional user-based information may include the student's age, grade level, reading level, current class, related reading lesson, and related words that are predicted to be challenging for the student.

The reading engine 110 generates a narrative as part of one or more chapters. As can be appreciated, a story or narrative typically follows a sequence of events, such as an introduction, action, and resolution. As such, the reading engine 110 may generate one or more chapters following a storyline sequence. For example, the reading engine 110 may generate a first chapter that introduces settings and characters within the narrative, a second chapter which provides an action sequence for the narrative, and a third chapter providing resolution to the narrative. As will be described in greater detail below, the number of chapters may depend on user-based information (e.g., grade level, reading level) of the associated student.

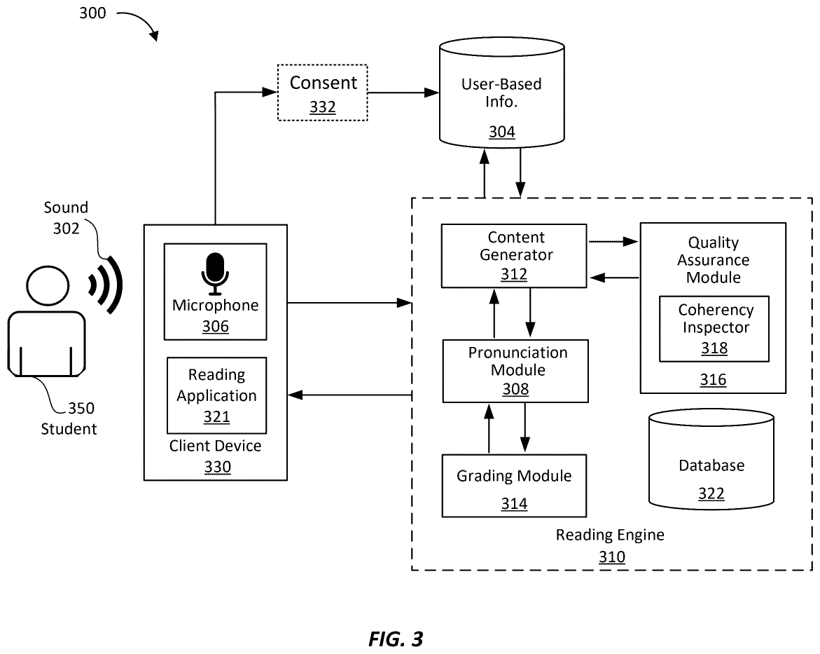

When generating a chapter of the narrative, the reading engine 110 includes one or more challenge words. The challenge words may be words that the student finds difficult to read or pronounce. The challenge words may be selected by an educator, identified based on a student's reading of a respective chapter, or identified based on earlier exercises. That is, the reading engine 110 may identify the challenge words based on the student's mispronunciation of the words during an earlier exercise or a reading of a present chapter. To aid the student in learning the words and how to pronounce the words, the reading engine 110 incorporates the challenge words into a subsequently generated chapter. Generation of the chapters within the narrative to include challenge words and identification of challenge words are described in greater detail below with respect to FIGS. 3-8.

Once generated by the reading engine 110, a chapter 135 of the narrative is provided to user B via a user interface 131 of an application (e.g., reading exercise application) executing on the client device 130. As illustrated, the user interface 131 may provide a reading exercise 133 including the generated chapter 135. User B can read the chapter 135 via the user interface 131. In some cases, user B reads the chapter 135 out loud and user B's reading is evaluated by the reading engine 110. Once user B completes the reading of the chapter 135, user B is prompted with multiple options on how the narrative present in the chapter 135 should continue. Upon selection of one of the options, the reading engine 110 then generates a subsequent chapter based on the option selection, the narrative present in the chapter 135, and the challenge words. Evaluation of user B's reading of the chapter 135, along with the identification of challenge words and prompting of narrative options are described in greater detail below with respect to FIGS. 3-8.

Once user B completes the chapter 135 and/or the reading exercise 133, the reading engine 110 may generate a report of the interaction. As can be appreciated, during a reading of the chapter 135 (or all the chapters within the reading exercise 133), the student may interact with the words present in the chapter 135 in a variety of manners. For example, the student may mispronounce words, omit words, insert words, skip sentences or pages completely, or may completely fail to read the chapter 135 at all. The student may skip ahead or repeatedly return to a given word, sentence, or page. In other words, the student may interact with the narrative present in the reading exercise 133 in a variety of manners, each of which may be monitored and captured by the reading engine 110 in a report or summary of the reading exercise 133 for the student.

The summary may be provided to user C, who may be an educator in this scenario. User C may view the summary via a user interface 141 via an application executing on the client device 140. As illustrated, the user interface 141 may include a summary 143 of the exercise as completed by user B via the user interface 131. As will be described in greater detail below, the summary 143 may include various metrics that indicate user B's reading progress for a given exercise.

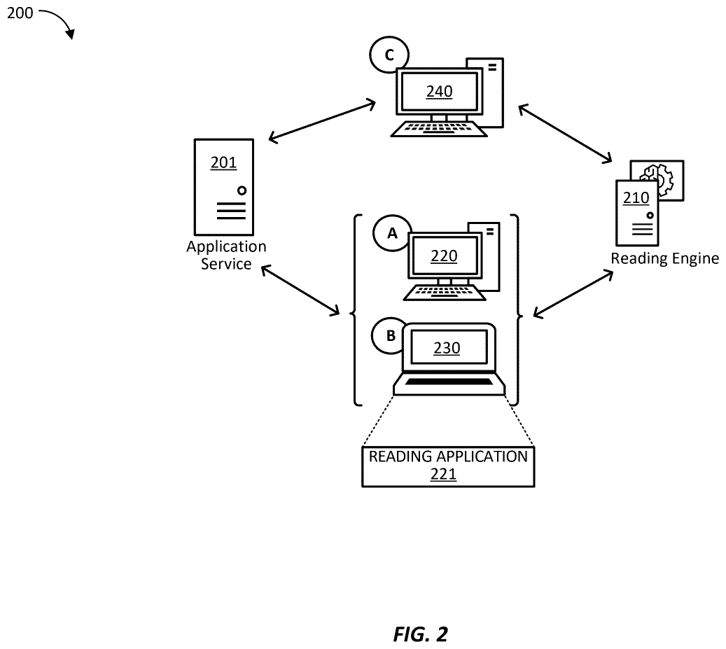

Turning now to FIG. 2, FIG. 2 illustrates a brief operational scenario 200 to further highlight an application of the reading engine, according to an embodiment provided herein. As shown, in operational scenario 200, there are two observed users (e.g., students), users A and B, and a reviewing user (e.g., educator), user C. Users A and B may operate the client devices 220 and 230, respectively, which may be the same or similar to the client devices 120 and 130 described above with respect to FIG. 1. Similarly, user C may operate the client device 240, which may be the same or similar to the client device 140. In some cases, the reviewing user may be the same as the observed user. For example, the user A may perform one or more of the functions described below with respect to the reviewing user. As should be appreciated, the user A (e.g., a student) may desire to practice, track, or otherwise review his or her reading progress.

Following the above example for user B, user B may open an application, such as a reading application 221 (e.g., an education-based collaboration application), to begin a reading exercise. To open the application, the client device 230 may communicate with an application service 201, which may be the same or similar to the application service 101. The application service 201 may initiate and operate the reading application 221 on the client device 230. Once the application is open on the client device 230, user B may begin a reading exercise within the reading application 221 by, for example, selecting a narrative to follow for the exercise and reading respectively generated chapters for the narrative.

The reading application 221 provides enhanced and adaptive reading exercises as generated by reading engine 210. The reading engine 210 may be the same or similar to the reading engine 110. As such, in some embodiments, upon initiating the reading application 221 on the client device 230, software corresponding to the reading engine 210 may also be initiated. That is, settings associated with the reading application 221 may indicate a certain exercise is handled (e.g., generated and tracked) by the reading engine 210. For example, if user C is an educator, user C may have prepared a reading exercise to be completed in the reading application 221. As part of the exercise, user C may have selected a setting to have the reading engine 210 generate the narrative present within the reading exercise based on the completing student, here user B, and observe the completion of the exercise. As such, the reading engine 110 generates the narrative, including the chapters, within the reading exercise based on user-based information for user B, such as what words user B finds challenging, and provides the narrative to user B via the reading application 221.

As user B completes the reading exercise via the reading application 221, the reading engine 210 observes user B's interactions with the narrative. For example, the reading engine 210 tracks which challenge words user B accurately pronounces and which challenge words the user B inaccurately pronounces. Beyond noting what challenge words user B inaccurately pronounces, the reading engine 210 observes how user B incorrectly pronounces a respective challenge word. As will be described in greater detail below, when the reading engine 110 identifies an incorrectly pronounced challenge word, the reading engine 110 determines whether the incorrect pronunciation is a mispronunciation, an omission, or an insertion.

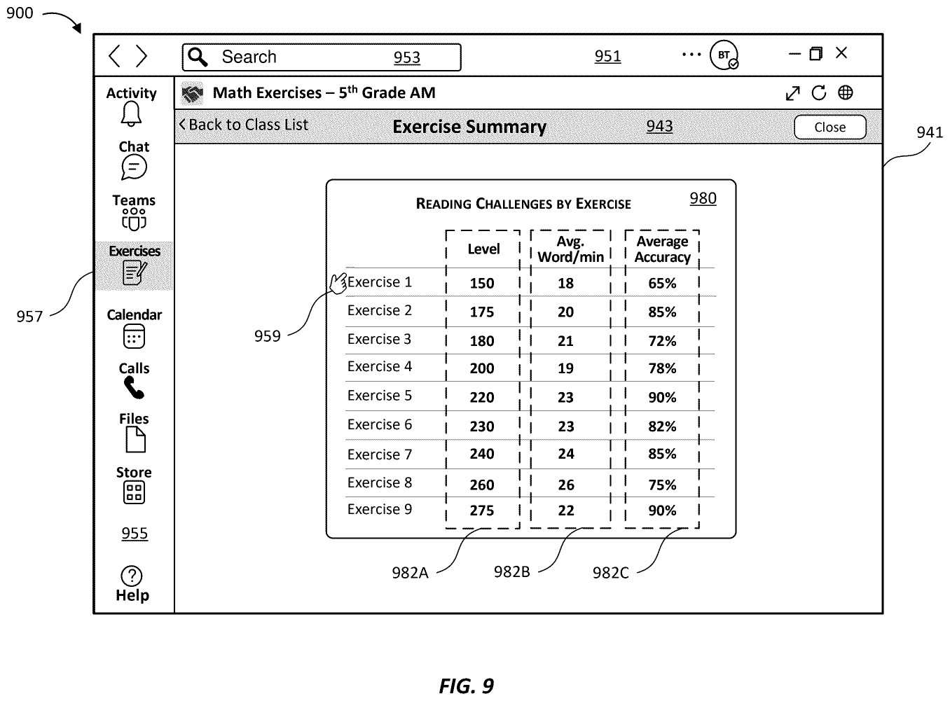

After a student completes and submits the reading exercise via the reading application 221, the reading engine 210 generates a report or summary of the reading exercise. The report may indicate any challenge words that the student mastered or fumbled on during a given exercise. The report may also provide various metrics, such as an average words per minute or average accuracy for the reading exercise. Additionally, the reading engine 210 may generate a summary that provides metrics on user B's progress with respect to other students within a class. For example, the reading engine 210 can generate a summary showing user B's accuracy on challenge words for a given exercise with respect to a class average or other students within his or her class, or other students at the same reading level. Reports and summaries generated by the reading engine 210 are discussed in greater detail below, in particular, with respect to FIGS. 9-11.

Turning now to FIG. 3, a system 300 for providing a reading engine 310 is illustrated, according to an embodiment herein. The system 300 includes the reading engine 310 and a client device 330, which may be the same or similar to the reading engine 110 and the client device 130, respectively. The reading engine 310 provides enhanced reading exercises for a student 350 of the client device 330. For ease of discussion the user of the client device 330 is described as a student within an educational environment, however, it should be appreciated that other scenarios are also contemplated.

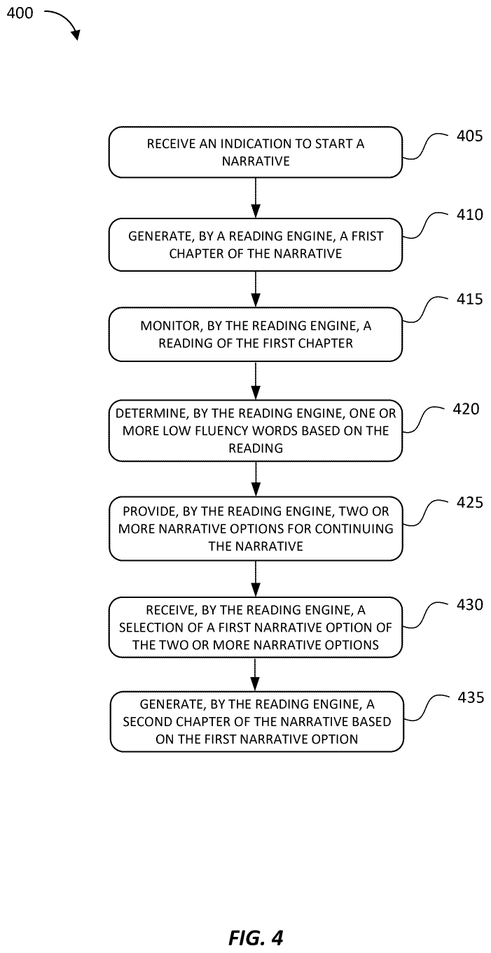

For case of explanation, FIG. 3 is described in combination with FIG. 4. FIG. 4 illustrates a process 400 for providing the reading engine 310 and its related functions, according to an embodiment herein. The process 400 may also be noted as the reading engine process 400 herein. Although the process 400 is described with respect to components and elements of FIG. 3, it should be appreciated the one or more steps of the process 400 may be executed or applied to components or elements of any other Figure provided herein.

To begin, the student 350 corresponding to the client device 330 starts a reading exercise. For example, the client device 330 provides an indication, such as opening a reading application 321, to begin the reading exercise. The reading exercise includes a narrative to be read by the student 350. As such, upon starting the reading exercise the reading engine 310 receives an indication to start the narrative (405). Responsive to receiving the indication to start the narrative, the reading engine 310 generates a first chapter of the narrative (410). In some cases, the reading engine 310 generates the first chapter of the narrative prior to receiving the indication from the client device 330 and instead provides the first chapter of the narrative to the client device 330 responsive to the indication to start.

To generate the first chapter of the narrative, the reading engine 310 includes a content generator 312. The content generator 312 may be a text-to-text generative model, such as a large language model (LLM), or may be a text-to-image generative model. Examples include generative pre-trained transformer models or multimodal generative models. Although only one content generator 312 is illustrated, it should be appreciated, the reading engine 310 may include more than one content generator 312, including different types of content generators 312.

The content generator 312 may generate the first chapter of the narrative based on the client device 330. For example, the content generator 312 may generate the first chapter of the narrative based on user-based information 304 associated with the client device 330. The user-based information 304 may be stored in a user-based information repository or database hosted by the reading engine 310 or by a separate third party. The user-based information 304 associated with the client device 330 may include information associated with the student 350 of the client device 330, such as the student's 350 age, grade, class information, curriculum, or current lesson plan. As can be appreciated, using information such as the student's 350 grade or class information (e.g., first grade vs. fifth grade), the narratives generated by the content generator 312 are appropriate for the student and the associated class.

The user-based information 304 also includes one or more challenge words for the student 350. The challenge words may be selected by an educator for a given reading exercise. In other cases, the challenge words may be determined by the reading engine 310 for the student 350 based on previous readings. In still additional cases, the challenge words may be determined by a combination of being selected by the educator for a given exercise and determined by the reading engine 310 based on the student's 350 previous readings. As used herein, challenge words may be words that are new to the student 350 or that the student 350 struggles with. As can be appreciated, the student 350 may struggle with a word by mispronouncing the word, omitting the word, or inserting the word or non-related words in its place.

Additional user-based information 304 that may be used to generate a narrative for the student 350 may include the student's narrative preferences. That is, the reading engine 310 may identify that the student 350 prefers specific characters, storylines, or scenes based on the student's 350 previous exercises. For example, the reading engine 310 may determine that the student 350 prefers adventure storylines that include animals based on the student's 350 increased duration of interaction with narratives that involve these items. As such, when generating subsequent narratives for the student 350, the reading engine 310 may generate narratives using the student's 350 preferences (e.g., adventure storylines involving animals as the main characters).

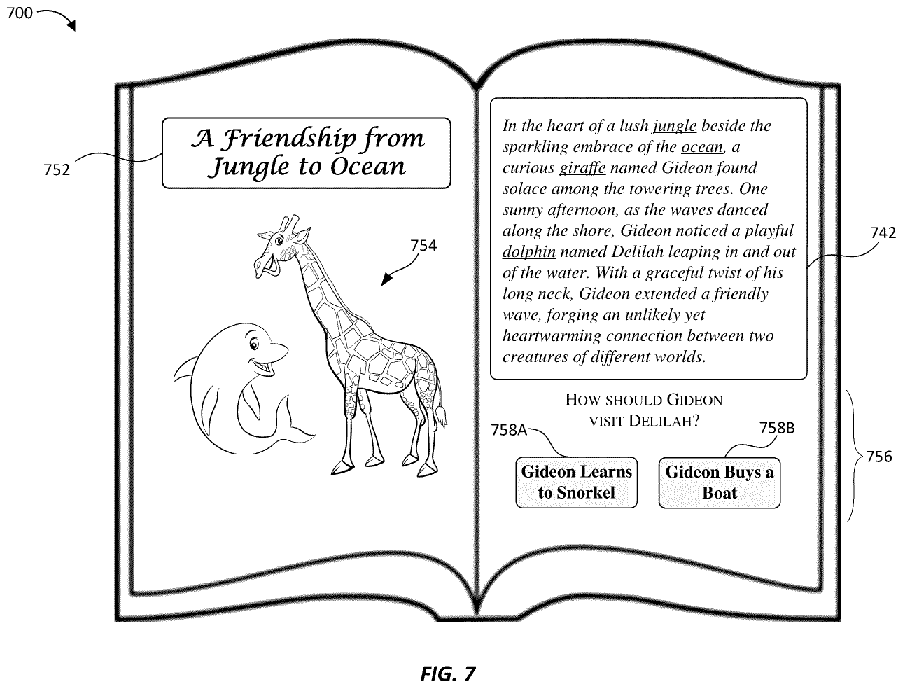

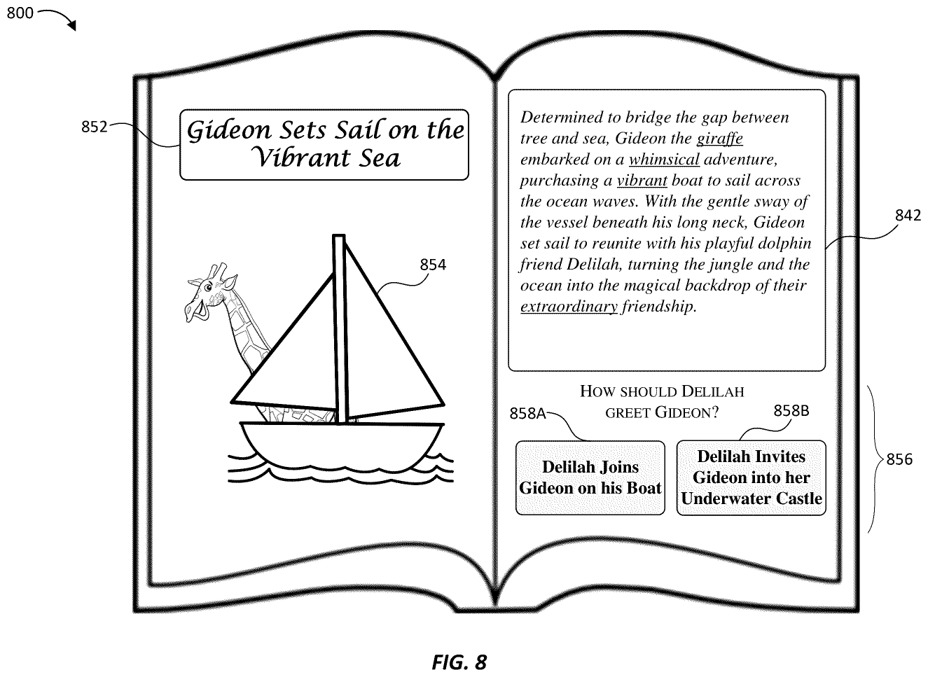

Once the first chapter of the narrative is generated by the content generator 312 for the student 350, the first chapter is provided to the student 350 via the reading application 321 executing on the client device 330. Although, the reading application 321 is illustrated as on the client device 330, it should be appreciated that the reading application 321 may be remotely executed, web-based, or locally executed, as described above with respect to the reading application 221. Illustrative examples of how a chapter of a narrative is provided to the student 350 are provided with respect to FIGS. 7 and 8, and further described in detail with respect to these figures.

As part of the reading exercise, the student 350 reads the first chapter out loud. That is, the student verbalizes each word of the first chapter as sound 302. The sound 302 from the student 350 reading the first chapter is captured by a microphone 306. The microphone 306 may be part of the client device 330 or may be separate from the client device 330 but operably coupled to the client device 330 such to provide the sounds 302 from the student's reading to the reading application 321. The student's 350 reading of the first chapter is monitored by the reading engine (415). In particular, the sounds 302 of the student's 350 reading of the first chapter is captured by the microphone 306, provided to the reading application 321, where the reading is provided to the reading engine 310 for evaluation.

Upon receiving the student's 350 reading of the first chapter, the reading engine 310 determines one or more low fluency words based on the reading (420). To determine the low fluency words from the reading, the reading engine 310 includes a pronunciation module 308. The pronunciation module 308 evaluates the student's 350 reading of the first chapter for accuracy. In particular, the pronunciation module 308 evaluates the student's 350 pronunciation of the challenge words that are present in the first chapter. As can be appreciated, pronunciation of a challenge word involves the accurate articulation of its sounds, encompassing the proper production of phonemes, intonation, and rhythm. It also entails understanding and adhering to the linguistic rules governing stress patterns and syllabic emphasis within the context of a given language.

In addition to evaluating the student's 350 pronunciation of challenge words within the reading, the pronunciation module 308 also evaluates the reading for omissions or insertions with respect to challenge words. As can be appreciated, if the student 350 finds a challenge word too difficult, then the student 350 may omit the challenge word during the reading. In another scenario, the student 350 may insert another word in place of the challenge word instead of reading the challenge word. Any challenge word that is mispronounced, omitted, or inserted may be considered a low fluency word. As such, the reading engine 310, in some cases via the pronunciation module 308, identifies one or more low fluency words present within the student's 350 reading of the first chapter.

Once the reading engine 310 identifies one or more low fluency words from the reading of the first chapter, these low fluency words may be tagged as challenge words for the student 350 and stored as part of the user-based information 304 for subsequent narratives (e.g., follow-up chapters or reading exercises). In some cases, consent 332 may be requested from the student 350 prior to storing the identified challenge words from a reading or any of the other user-based information 304. For example, when the user opens the reading application or downloads software corresponding to the reading application, the user may be prompted to provide consent 332 for the reading engine 310 to observe and store user-based information relating to the client device 330. By storing the challenge words identified from the reading of the first chapter, the reading engine 310 can generate subsequent narratives to include the challenge words. In this manner, the reading engine 310 tailors narratives to the student 350, individualizing reading exercises to the needs of that particular student 350.

Once the student 350 completes the first chapter of the narrative, the reading engine 310 provides two or more narrative options for continuing the narrative. For example, the reading engine 310 may generate a first option that continues the story with the main character taking a first action and generate a second option that continues the story with the main character taking a second action. Other examples of narrative options are described in greater detail below with respect to FIGS. 7 and 8. For case of explanation, only two narrative options are described for the embodiments herein, however, it should be appreciated that any number of narrative options may be provided to the student 350. In fact, in some cases, the student 350 may be able to write-in or provide a freeform narrative option for continuing the narrative.

The content generator 312 may generate the narrative options based on the first chapter. For example, the content generator 312 may first generate the content of the first chapter and then the first chapter may be submitted back to the content generator 312 with a request for two or more narrative options to be generated to continue the narrative present in the first chapter. Based on this request, the content generator 312 generates the narrative options for continuing the storyline present in the first chapter. In some cases, the content generator 312 may also generate the narrative options based on where the next chapter falls within the storyline sequence. For example, if the next chapter that will be generated is the final chapter of the narrative, then the content generator 312 may generate the narrative options to involve resolution of the narrative. In such an example, the content generator 312 is provided with the information of the previous chapter (e.g., the content, a summary, or a snippet of the previous chapter) and request to generate narrative options for resolving the narrative present in the previous chapter.

The narrative options are provided to the client device 330 by the reading engine to continue the narrative (425). The student 350 is prompted to select one of the narrative options for continuing the narrative. Prompting of the student 350 with various narrative options is described below with respect to FIGS. 7 and 8. Upon selection of a narrative option, the reading engine 310 receives the student's 350 selection of the narrative option (430) and generates a subsequent chapter, here a second chapter.

The reading engine 310 generates a second chapter of the narrative based on the selected narrative option (435). That is, the content generator 312 generates the second chapter of the narrative to continue the storyline along the narrative option selected by the student 350. The content generator 312 also generates the second chapter to contain one or more challenge words. In some cases, the challenge words for the second chapter may be the same as the challenge words present in the first chapter. In other cases, the challenge words may be the low fluency words identified by the reading of the first chapter, or some combination thereof. In additional cases, the challenge words may also include related words. Related words may be words that the reading engine 310 identified as related to the challenge words or low fluency words that the student 350 finds challenging.

Additionally, the content generator 312 generates the second chapter based on the first chapter to ensure coherency between the first chapter and the second chapter. That is, the content generator 312 generates the second chapter to be coherent and continues the storyline present in the first chapter. As such, the content generator 312 may generate the second chapter using continuity information based on the first chapter. Continuity information may be or include the whole first chapter, a snippet of the first chapter, or a summary of the first chapter.

To ensure that a quality narrative is generated for the student 350, the reading engine 310 may include a quality assurance module 316. The quality assurance module 316 may include a coherency inspector 318 that evaluates and ensures that the narrative between the first chapter and the second chapter are coherent. For example, related chapters of a given narrative may be submitted to the coherency inspector 318 which scores the coherency of the chapters. If two chapters are determined to be incoherent or have low coherency, then the subsequent chapter may be resubmitted to the content generator 312 along with a request for it to be regenerated to be more coherent with the previous chapter.

The quality assurance module 316 may also validate the quality of the narrative. For example, chapters or narratives for various reading exercises may be sampled and evaluated based on a variety of quality parameters. For example, a chapter may be selected by the quality assurance module 316 and the chapter may be evaluated to validate whether the narrative is appropriate for the student 315's age, grade level, reading level, etc. Additional quality parameters that the quality assurance module 316 may evaluate are how well challenge words are integrated into the narrative, how engaging or creative the storyline is (e.g., how long students spent reading the narrative), or how appropriate the title of the chapter is. In some cases, the quality assurance module 316 may generate a quality score based on the evaluation of the quality parameters and chapters that fall below a quality score threshold may be resubmitted to the content generator 312 with a request to improve the quality of the narrative.

In addition to generating chapters of a given narrative, the reading engine 310 may also generate a title for each respective chapter and/or cover image. In other words, for each chapter, the content generator 312 may generate a respective title for that chapter. Similarly, for each chapter, the content generator 312 may generate a respective cover image for that chapter. As will be described in greater detail below, in some embodiments, the content generator 312 may be prompted to generate a respective title or cover image to include one or more of the challenge words. As can be appreciated, by including a challenge word as part of the cover image, the student 350 is provided with a visual cue on the challenge word, thereby heightening his or her comprehension of the challenge word.

In addition to evaluating the student's 350 accuracy of reading, the reading engine 310 may also grade or otherwise generate a summary of the student's interaction with the reading exercise. For example, the reading engine 310 may include a grading module 314 that grades the student's 350 completion of the reading exercise. The grading module 314 may determine whether the student 350 completed the reading exercise, completed the reading exercise by an exercise due date, how the student 350 performed during the reading exercise, and the like. Performance of the student 350 during a given reading exercise may include a number of words per minute, how long it took for the student to complete a reading exercise (e.g., it took the student 10+ tries to complete the exercise), and the accuracy of the student's 350 reading of the reading exercise.

The grading module 314 may also generate a report or summary of the student's 350 grade for the reading exercise. The report or summary generated by the reading engine 310 may be provided to an educator or reviewer. Such an example is described in greater detail below with respect to FIGS. 9-11. As can be appreciated, by providing a summary of how the student interacted with the reading exercise, the educator can evaluate what materials need to be covered in subsequent lessons and gather across all of the students within a given class where the class is with reading comprehension and challenge words.

In some cases, the reading engine 310 also includes a database 322 for storing generated content. For example, the database 322 may store images that may be used by the content generator 312 for generation of cover images. The database 322 may also store the chapters of a narrative as they are generated by the content generator 312. As can be appreciated, computing resource requirements may be reduced by retrieving previously generated chapters, cover images, chapter titles, and the like, instead of generating this content for each student for every exercise. As such, in some cases, instead of generating new content for any of the above referenced generation steps, the reading engine 310 may retrieve the respective content from the database 322 and provide it to the reading application 321 as part of the narrative.

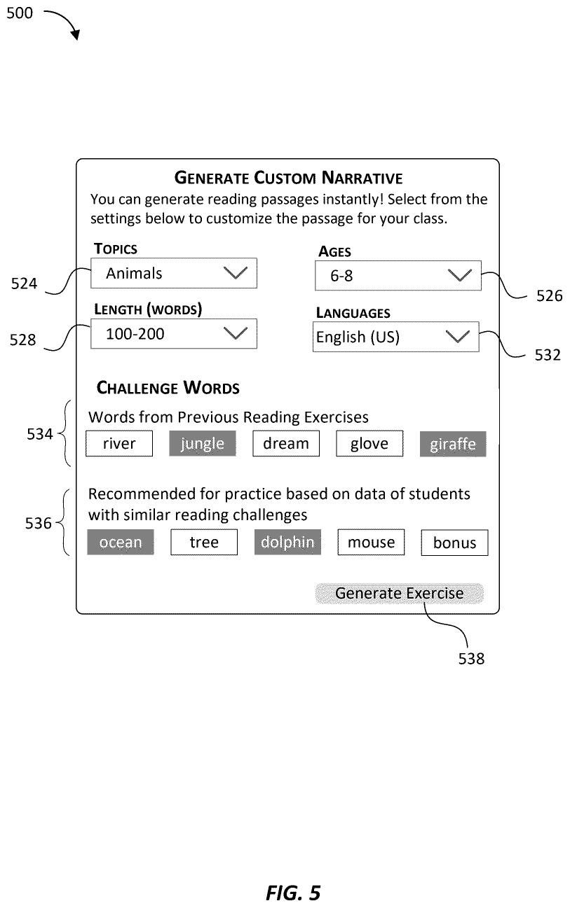

Turning now to FIG. 5, an example prompt 500 for generating a narrative using the reading engine, is provided according to an embodiment herein. The prompt 500 may be provided to an educator as part of a reading exercise generation process. For example, the prompt 500 may be provided to user C on the client device 140 to generate a reading exercise for users A and B.

As shown, the prompt 500 provides various options to which the educator can define the parameters of a given reading exercise. For example, the prompt 500 includes a topic option 524 and an age option 526. The topic option 524 allows the educator to select a general theme or topic for a narrative within the reading exercise. Here, the educator selected Animals as the topic for the narrative. Similarly, the age option 526 allows the educator to specify the age group for the narrative. As can be appreciated, ensuring that the reading exercise is age-appropriate is crucial because it tailors the content to match the cognitive and emotional development of the readers, maximizing their comprehension and engagement. Age-appropriate materials promote a positive reading experience, fostering a sense of relevance and connection that can significantly impact a student's interest in learning and overall literacy development.

The prompt 500 also includes a length option 528 and language option 532. The length option 528 allows the educator to specify a word count or narrative length for a given narrative and the language option 532 allows an educator to specify the language in which the narrative is generated. In some cases, the length option 528 may specify the length of each chapter within a given narrative or the overall length of the narrative.

The educator can also select one or more challenge words to include in a reading exercise. For example, the prompt 500 may include challenge words 534 that allow the educator to select challenge words for a current exercise from words that were identified by the reading engine from previous reading exercises. That is, the challenge words 534 may include challenge words that were identified as challenge words based on readings by students from previous exercises. In some cases, the educator may be able to input desired challenge words instead of selecting from previously identified challenge words.

The prompt 500 may also provide related words 536. The related words 536 may be words identified by the reading engine 310 as related to the challenge words. For example, the word “giraffe” is a challenge word for a student, and other students who struggle with the word “giraffe” also struggle with the word “dolphin,” the reading engine may identify “dolphin” as a related word to “giraffe.” As such, when generating a new reading exercise, the educator may be prompted to select challenge words from related words 536. As should be appreciated, related words 536 may be words involving the same subject matter (e.g., animals) or words that have similar features, such as similar sounds or phonetic arrangements. In some cases, the related words 536 may be words that other students 350 find challenging, such as the above example in which “dolphin” is identified as a related word 536 to “giraffe.”

Once the educator selects challenge words for the reading exercise, the educator can select the option 538 to generate the reading exercise. Upon selection of the option 538, the reading engine, such as the reading engine 110, generates a first chapter of a narrative following the options selected within the prompt 500.

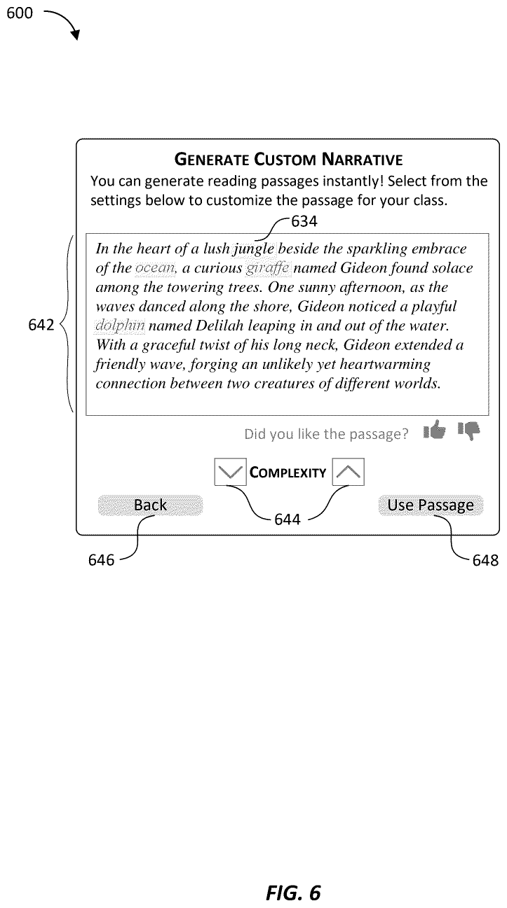

Turning now to FIG. 6, an example narrative generated by a reading engine is illustrated, according to an embodiment herein. As shown, a prompt 600 may be provided to an educator as part of generating a reading exercise. That is, the prompt 600 may allow the educator to review a first chapter or portion of the first chapter of a narrative for a reading exercise before generating the reading exercise. This can allow the educator to modify various parameters surrounding a reading exercise before the reading exercise is completely generated and provided to students.

As shown, the prompt 600 includes a passage 642. The passage 642 may correspond to a first chapter of a narrative for a given reading exercise. The passage 642 may be generated by a content generator, such as the content generator 312, of the reading engine based, in part, on the parameters selected by the educator in the prompt 500. As such, the passage 642 includes challenge words 634 that were selected by the educator.

Upon reviewing the passage 642, the educator may tailor or customize the passage 642. For example, the educator may modify the complexity 644 of the passage 642. That is, the educator may increase or decrease the complexity 644 of the reading passage 642 based upon review. In some cases, to change the complexity 644 (based on an educator's selection to either increase or decrease the complexity 644) the reading engine may prompt the content generator 312 to change the complexity based on the educator's selection. For example, the reading engine may submit the passage 642 to the content generator 312 with the request to increase the complexity of the passage 642.

If the educator desires to make any other changes to the parameters of the passage 642, the educator may select a back option 646 to return to the prompt 500. If the educator, however, approves of the passage 642, the educator may select the use passage option 648. Upon selection of the use passage option 648, the reading engine may generate a reading exercise based on the passage 642. For example, the reading exercise may start with a first chapter of a narrative including or starting with the passage 642.

Turning now to FIG. 7, an example first chapter 700 of a narrative is provided, according to an embodiment herein. The first chapter 700 may be part of a reading exercise generated based on the passage 642 of FIG. 6. As shown, the first chapter 700 includes a passage 742 that is similar to the passage 642. As such, the passage 742 is generated by the reading engine to include the challenge words, which are underlined within the passage 742 for identification.

As described above with respect to FIG. 3, as part of generating the first chapter 700, the reading engine, in some embodiments, also generates a chapter title 752 and a cover image 754. To facilitate a student's comprehension of the challenge words, the chapter title 752 may be generated by the reading engine to include one or more of the challenge words. Here, the challenge words include “Jungle” and “Ocean.” As such, the chapter title 752 also includes these terms. Similarly, the cover image 754 may also be generated to include the challenge words. The challenge words for the presently illustrated reading exercise include “dolphin” and “giraffe.” As such, the cover image 754 is generated by the reading engine to include these challenge words.

As part of the reading exercise, a student may read the first chapter 700. For example, the student may read the passage 742 out loud. Upon completion of the first chapter 700 or the passage 742, the student may be prompted with two or more narrative options 756 for continuing the narrative. As shown, for the narrative present in the passage 742, the student is provided with a first narrative option 758A and a second narrative option 758B. The first narrative option 758A includes the option for the narrative to continue by Gideon learning to snorkel and the second narrative option 758B includes the option for the narrative to continue by Gideon buying a boat. Depending on which of the narrative options 756 the student selects, the narrative for subsequent chapters will diverge from the narrative provided to other students.

Referring now to FIG. 8, an example second chapter 800 of the narrative provided in FIG. 7 is illustrated, according to an embodiment herein. The second chapter 800 is generated based, in part, on the selection of the narrative options 756 by the reading student. Here, the student selected the second narrative option 758B in which Gideon buys a boat. As such, the second chapter 800 is generated following the selected narrative option in which Gideon buys a boat.

As shown, the second chapter 800 includes a passage 842. The passage 842 is generated by the reading engine to include challenge words identified based on the reading of the first chapter 700 by a respective student. As described above with respect to FIG. 3, as a student reads the first chapter 700, the reading engine identifies low fluency words based on the reading. The low fluency words are tagged as challenge words or that student. As such, the low fluency words identified from the reading of the first chapter 700 are incorporated into the second chapter 800 of the reading exercise. In this manner, the reading engine resurfaces low fluency words during a reading exercise, and/or in subsequent exercises, to facilitate learning of the low fluency words by the student.

Depending on how many or if any low fluency words are identified during reading of a preceding chapter, the reading engine may select additional challenge words to incorporate into the passage 842. For example, the reading student may have only stumbled on the word “giraffe” during the first chapter 700. As such, additional challenge words, such as “whimsical,” “vibrant,” and “extraordinary,” are incorporated into the passage 842. These additional challenge words may be words selected by the educator as part of the reading exercise generation process, may be selected by the reading engine based on previous reading exercises, or may be related words identified by the reading engine.

In addition to the passage 842, the second chapter 800 may include a chapter title 852 and a cover image 854. As described above, the chapter title 852 and/or the cover image 854 may be generated to include or incorporate one or more of the challenge words.

Depending on the length of the reading exercise, and thus the narrative, the second chapter 800 may include narrative options 856 for continuing the narrative in a subsequent chapter. If the second chapter 800 was a final chapter of the reading exercise, then the narrative options 856 may not be provided to the student. Here, however, the narrative options 856 are provided, prompting the student to select between a first narrative option 858A and a second narrative option 858B. Depending on which of the narrative options 856 the reading student selects, the reading engine will generate a subsequent chapter following the selected narrative option.

Turning now to FIGS. 9-11, various user interfaces are provided in an education-based scenario to demonstrate various facets of the reading engine, and its related functions, as disclosed herein. It should be appreciated, however, that although the following discussion relates to an education-based scenario that the concepts apply as well to other settings, situations, and scenarios.

Beginning with FIG. 9, FIG. 9 illustrates a GUI 900 for providing a reading engine, according to an embodiment herein. Specifically, the GUI 900 illustrates a user interface 941 that a reviewing user, such as an educator, may interact with. For example, the GUI 900 may illustrate an example user interface 141, as referenced in FIG. 1, provided to user C via the client device 140.

The user interface 941 includes components associated with a reading application (e.g., the reading application 221 in FIG. 2), including components 951, 953, 955, and 957. The component 951 is representative of a main title bar that allows a reviewing user to, among other functions, open, close, minimize, or maximize user interface 941. The component 951 includes a search box 953 via which a user may input search queries with respect to content in the reading application such as exercises, class lists, and class materials.

The component 955 is representative of a feature bar that includes various icons for accessing modules of the application. For instance, the component 955 includes an activity icon for checking alerts or reminders, a chat icon for chatting with other users, an icon for accessing team-oriented flows, an exercises icon for posting and reviewing exercises, a calendar icon for accessing a calendar feature, a call icon for placing voice calls, a files icon for managing files, and a store icon for accessing an app store. In some implementations, the component 955 may include an icon for accessing a reading engine, a reading engine add-in application, or the like.

The app store—accessible via the store icon—provides the user with the ability to download and install “add-in” applications that are integrated into the context of the main application. Here, it is assumed for exemplary purposes that the user has installed a reading engine through the store (or by another mechanism) or that the reading application includes the reading engine otherwise installed therein. As illustrated in FIG. 9, the reading engine can be loaded and executed in the context of another application, such as the reading application 221 described with respect to FIG. 2.

In the illustrated example, an educator may navigate to an exercise summary 943. The exercise summary 943 may include a report 980 for students within a class, here a 5^{th} grade morning class. The report 980 is generated by a reading engine, such as the reading engine 110 or 310. The report 980 may provide various metrics on each exercise, including an average performance by students within the class. The various metrics provided by the report 980 includes a reading level 982A, an average word per minute 982B that students read the reading exercise at, and an average accuracy 982C for a reading by each of the students. As can be appreciated, the report 980 may provide vital information to the educator on how well the students within a class are progressing or what needs to be revisited to aid the students with their learning process.

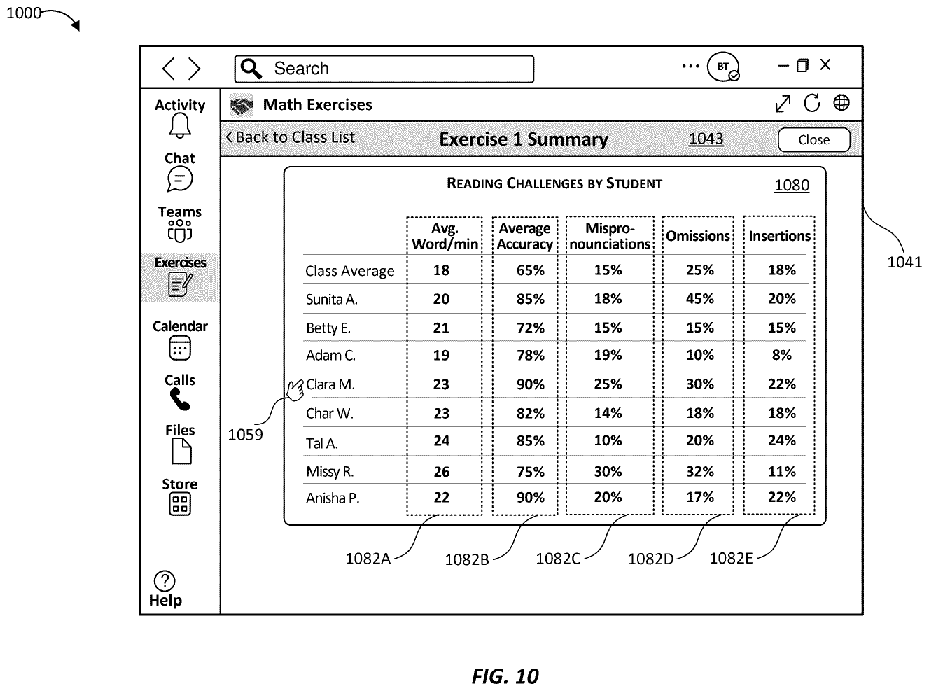

In some embodiments, the educator may select an exercise using a cursor 959 to view individual student metrics for that particular exercise. Referring now to FIG. 10, a GUI 1000 is provided illustrating metrics by student within a class for a reading exercise, according to an embodiment herein. The GUI 1000 may be provided to a reviewing user, such as an educator, by an interface 1041. The interface 1041 may include an exercise 1 summary 1043. The exercise 1 summary 1043 may include a report 1080 of how students within a class performed on a reading exercise.

As illustrated, the report 1080 provides metrics 1082A-E for each student within a class on a given exercise. The metrics 1082A-E provided in the report 1080 include an average word/min metric 1082A, an average accuracy metric 1082B, a mispronunciation metric 1082C, an omission metric 1082D, and an insertion metric 1082E. The average word/min metric 1082A indicates how fast a student reads the narrative within a reading exercise and the average accuracy metric 1082B indicates how accurately the student reads the narrative. As described above, the accuracy metric 1082B may include how well the student pronounces the challenge words present within the reading exercise. As such, the report 1080 includes the mispronunciation metric 1082C, the omission metric 1082D, and the insertion metric 1082E.

From report 1080, the educator can appreciate which concepts, such as slowing down to read or word pronunciation, to focus future lessons on and what concepts the students understand. If the educator desires to review a student's specific metrics, the educator can select a student's name from within the report 1080 with a cursor 1059. Upon selection of the student's name, the educator may be provided with a GUI illustrating that specific student's metrics with respect to a given reading exercise, or in some cases, metrics for all exercises within a desired time range (e.g., past month or semester).

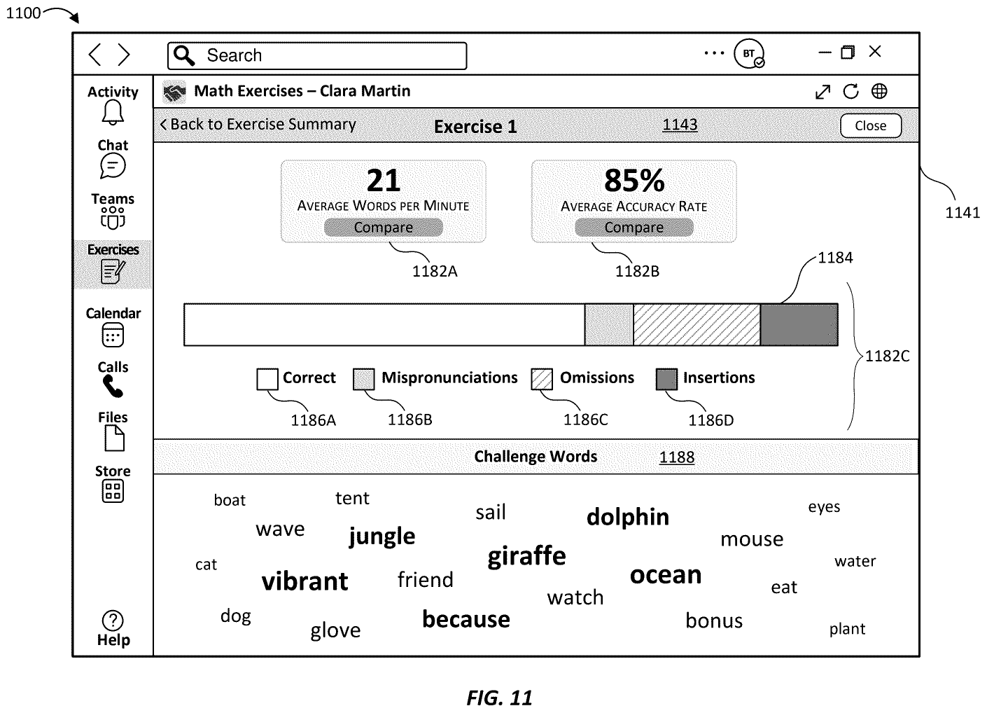

Turning now to FIG. 11, a GUI 1100 is provided illustrating a submitted exercise view, according to an embodiment herein. The GUI 1100 includes a user interface 1141, which may be the same or similar to the user interface 141 that is provided to a reviewing user (e.g., educator) via a client device. The user interface 1141 may include an exercise summary 1143. The exercise summary 1143 can include various metrics for a given exercise, such as an accuracy, for the selected student. Here, the exercise summary 1143 provides metrics for Clara Martin for exercise 1.

As shown, the exercise summary 1143 includes metrics 1182A and 1182B that show how well Clara performed on the reading exercise 1. The metric 1182A indicates how many words per minute she read the narrative of the exercise and the metric 1182B provides the average accuracy rate she performed at for the exercise. A metric 1182C is also provided that depicts Clara's pronunciation of challenge words within the exercise. As shown, the metric 1182 includes a bar graph 1184 depicting what portion of Clara's reading of the challenge words within the narrative were correct 1186A, mispronounced 1186B, omitted 1186C, and inserted 1186D.

In addition to the metrics 1182A-C, the exercise summary 1143 includes a challenge word frequency chart 1188. The challenge word frequency chart 1188 provides a visual display of the frequency of challenge words within the respective exercise. As can be appreciated, the challenge word frequency chart 1188 identifies the most commonly used words as well as all the challenge words present within the exercise.

Referring to FIG. 12, FIG. 12 illustrates a computing system 1201 that may be used for providing a reading engine and related functions, as described herein. For example, the client device 120 or 130 may be or include the computing system 1201. As illustrated, the computing system 1201 includes a processing system 1202 that includes a microprocessor and other circuitry that retrieves and executes software 1205 from storage system 1203. The processing system 1202 may be implemented within a single processing device but may also be distributed across multiple processing devices or sub-systems that cooperate in executing program instructions. Examples of the processing system 1202 include general purpose central processing units, graphical processing units, application specific processors, and logic devices, as well as any other type of processing device, combinations, or variations thereof.

The storage system 1203 may comprise any computer readable storage media readable by processing system 1202 and capable of storing software 1205. The storage system 1203 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 1203 may also include computer readable communication media over which at least some of the software 1205 may be communicated internally or externally. The storage system 1203 may be implemented as a single storage device but may also be implemented across multiple storage devices or sub-systems co-located or distributed relative to each other. The storage system 1203 may comprise additional elements, such as a controller capable of communicating with the processing system 1202 or possibly other systems.

The software 1205 (including reading engine process 1206) may be implemented in program instructions and among other functions may, when executed by the processing system 1202, direct the processing system 1202 to operate as described with respect to the various operational scenarios, sequences, and processes illustrated herein. For example, the software 1205 may include program instructions for implementing a reading engine and related functions, as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 1205 may include additional processes, programs, or components, such as operating system software, virtualization software, or other application software. The software 1205 may also comprise firmware or some other form of machine-readable processing instructions executable by the processing system 1202.

In general, the software 1205 may, when loaded into the processing system 1202 and executed, transform a suitable apparatus, system, or device (of which computing system 1201 is representative) overall from a general-purpose computing system into a special-purpose computing system customized to generate features, functionality, and user experiences provided by the reading engine. Indeed, encoding the software 1205 on the storage system 1203 may transform the physical structure of the storage system 1203. The specific transformation of the physical structure may depend on various factors in different implementations of this description. Examples of such factors may include, but are not limited to, the technology used to implement the storage media of the storage system 1203 and whether the computer-storage media are characterized as primary or secondary storage, as well as other factors.

For example, if the computer readable storage media are implemented as semiconductor-based memory, the software 1205 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1207 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing system 1201 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a reading engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### Examples

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a system comprising: one or more computer readable storage media; one or more processors operatively coupled with the one or more computer readable storage media; and an application comprising program instructions stored on the one or more computer readable storage media that, when executed by the one or more processors, direct a computing system to at least: receive, from a first client device, an indication to start a narrative; generate, by a reading engine, a first chapter of the narrative based on the first client device, wherein the first chapter comprises a first set of challenge words; monitor, by the reading engine, a reading of the first chapter by the first client device; determine, by the reading engine, one or more low fluency words based on the reading of the first client device; provide, by the reading engine, two or more narrative options for continuing the narrative present in the first chapter; receive, by the reading engine, a selection of a first narrative option of the two or more narrative options; and generate, by the reading engine, a second chapter of the narrative based on the first narrative option, wherein: the second chapter comprises a second set of challenge words, the second set of challenge words comprises the one or more low fluency words; and the second chapter of the narrative is coherent with the first chapter of the narrative.

Example 2 is the system of any previous or subsequent Example, wherein the program instructions to generate, by the reading engine, the second chapter of the narrative cause, when executed by the one or more processors, to further direct the computing system to: provide continuity information for the second chapter of the narrative to a content generator, wherein the continuity information comprises: information on first chapter of the narrative; and the one or more low fluency words; and transmit, to the content generator, a request to generate the second chapter of the narrative based on the continuity information and the first narrative option; and receive, from the content generator, the second chapter of the narrative.

Example 3 is the system of any previous or subsequent Example, wherein the program instructions to generate, by the reading engine, the first chapter of the narrative based on the first client device cause, when executed by the one or more processors, to further direct the computing system to: determine, by the reading engine, user-based information associated with the first client device; determine, by the reading engine, a first set of challenge words based on the user-based information; and generate, by a content generator of the reading engine, the first chapter of the narrative based on the user-based information and the first set of challenge words.

Example 4 is the system of any previous or subsequent Example, wherein the program instructions further direct the computing system to: generate, by a content generator of the reading engine, a cover image for the second chapter based on the first narrative option, wherein the cover image for the second chapter comprises one or more elements related to the first narrative option.

Example 5 is the system of any previous or subsequent Example, wherein the program instructions further direct the computing system to: provide, by the reading engine, two or more additional narrative options for continuing the narrative present in the second chapter; receive, by the reading engine, a selection of a second narrative option of the two or more additional narrative options; and generate, by the reading engine, a third chapter of the narrative based on the second narrative option, wherein the third chapter of the narrative is coherent with the second chapter of the narrative.

Example 6 is the system of any previous or subsequent Example, wherein the program instructions to determine, by the reading engine, the one or more low fluency words based on the reading of the first client device cause, when executed by the one or more processors, to further direct the computing system to: identify, by a pronunciation function of the reading engine, within the reading of the first chapter of the narrative one or more of: a mispronunciation; a repetition; an insertion; or an omission.

Example 7 is a method comprising: receiving, from a first client device, an indication to start a narrative; generating, by a reading engine, a first chapter of the narrative based on the first client device, wherein the first chapter comprises a first set of challenge words; monitoring, by the reading engine, a reading of the first chapter by the first client device; determining, by the reading engine, one or more low fluency words based on the reading of the first client device; providing, by the reading engine, two or more narrative options for continuing the narrative present in the first chapter; receiving, by the reading engine, a selection of a first narrative option of the two or more narrative options; and generating, by the reading engine, a second chapter of the narrative based on the first narrative option, wherein: the second chapter comprises a second set of challenge words, the second set of challenge words comprises the one or more low fluency words; and the second chapter of the narrative is coherent with the first chapter of the narrative.

Example 8 is the method of any previous or subsequent Example, wherein: monitoring, by the reading engine, the reading of the first chapter by the first client device further comprises receiving, by the reading engine, an audio stream from the first client device of a user of the first client device reading the first chapter; and determining, by the reading engine, one or more low fluency words based on the reading of the first client device further comprises identifying, by the reading engine, one or more low fluency words based on audio within the audio stream.

Example 9 is the method of any previous or subsequent Example, the method further comprising: determining, by the reading engine, one or more additional low fluency words based on a reading of second chapter from the first client device; providing, by the reading engine, two or more additional narrative options for continuing the narrative present in the second chapter; receiving, by the reading engine, a selection of a second narrative option of the two or more additional narrative options; and generating, by the reading engine, a third chapter of the narrative based on the second narrative option, wherein: the third chapter comprises a third set of challenge words, the third set of challenge words comprising the one or more additional low fluency words; and the third chapter of the narrative is coherent with the second chapter of the narrative.

Example 10 is the method of any previous or subsequent Example, wherein generating, by the reading engine, the second chapter of the narrative comprises: providing, to a content generator, continuity information for the second chapter of the narrative, wherein the continuity information comprises: information on first chapter of the narrative; and the one or more low fluency words; and generating, by the content generator, the second chapter of the narrative based on the continuity information and the first narrative option.

Example 11 is the method of any previous or subsequent Example, the method further comprising: generating, by a content generator of the reading engine, ca cover image for the second chapter based on the first narrative option.

Example 12 is the method of any previous or subsequent Example, the method further comprising: determining, by the reading engine, one or more related words based on the low fluency words; and generating, by the reading engine, the second chapter of the narrative to include the one or more related words.

Example 13 is the method of any previous or subsequent Example, the method further comprising: submitting, by the reading engine, the second chapter of the narrative to a quality assurance engine; validating, by the quality assurance function, one or more quality parameters for the second chapter of the narrative; and generating, by the quality assurance function, a quality score for second chapter of the narrative based on the one or more quality parameters.

Example 14 is the method of any previous or subsequent Example, the method further comprising: submitting, by the reading engine, the first chapter and the second chapter of the narrative to a coherency inspector; and generating, by the coherency inspector, a coherency score for the first chapter and the second chapter of the narrative.

Example 15 is a computer readable storage media comprising processor-executable instructions configured to cause one or more processors to: receive, from a first client device, an indication to start a narrative; generate, by a reading engine, a first chapter of the narrative based on the first client device, wherein the first chapter comprises a first set of challenge words; monitor, by the reading engine, a reading of the first chapter by the first client device; determine, by the reading engine, one or more low fluency words based on the reading of the first client device; provide, by the reading engine, two or more narrative options for continuing the narrative present in the first chapter; receive, by the reading engine, a selection of a first narrative option of the two or more narrative options; and generate, by the reading engine, a second chapter of the narrative based on the first narrative option, wherein: the second chapter comprises a second set of challenge words, the second set of challenge words comprises the one or more low fluency words; and the second chapter of the narrative is coherent with the first chapter of the narrative.

Example 16 is the computer readable storage media of any previous or subsequent Example, wherein the processor-executable instructions to generate, by the reading engine, the first chapter of the narrative based on the first client device cause the one or more processors to further execute processor-executable instructions stored in the computer readable storage media to: determine, by the reading engine, user-based information associated with the first client device; determine, by the reading engine, a first set of challenge words based on the user-based information; and generate, by a content generator of the reading engine, the first chapter of the narrative based on the user-based information and the first set of challenge words.

Example 17 is the computer readable storage media of any previous or subsequent Example, wherein the processor-executable instructions cause the one or more processors to further execute processor-executable instructions stored in the computer readable storage media to: generate, by a content generator of the reading engine, a cover image for the second chapter based on the first narrative option and the one or more fluency words, wherein the cover image for the second chapter comprises one or more elements related to the first narrative option and the one or more fluency words.

Example 18 is the computer readable storage media of any previous or subsequent Example, wherein the processor-executable instructions cause the one or more processors to further execute processor-executable instructions stored in the computer readable storage media to: generate, by the reading engine, a title for the second chapter of the narrative, wherein the title of the chapter corresponds to the first narrative option.

Example 19 is the computer readable storage media of any previous or subsequent Example, wherein the processor-executable instructions cause the one or more processors to further execute processor-executable instructions stored in the computer readable storage media to: submit, by the reading engine, the second chapter of the narrative to a quality assurance engine; validate, by the quality assurance function, one or more quality parameters for the second chapter of the narrative; and generate, by the quality assurance function, a quality score for second chapter of the narrative based on the one or more quality parameters.

Example 20 is the computer readable storage media of any previous or subsequent Example, wherein the processor-executable instructions cause the one or more processors to further execute processor-executable instructions stored in the computer readable storage media to: determine, by the reading engine, one or more related words based on the low fluency words; and generate, by the reading engine, the second chapter of the narrative to include the one or more related words.

What is claimed is:

1. A system comprising:
one or more computer readable storage media;
one or more processors operatively coupled with the one or more computer readable storage media; and
an application comprising program instructions stored on the one or more computer readable storage media that, when executed by the one or more processors, direct a computing system to at least:
receive, from a first client device, an indication to start a narrative;
generate, by a reading engine, a first chapter of the narrative based on the first client device, wherein the first chapter comprises a first set of challenge words;
monitor, by the reading engine, a reading of the first chapter by the first client device;
determine, by the reading engine, one or more low fluency words based on the reading of the first client device;
provide, by the reading engine, two or more narrative options for continuing the narrative present in the first chapter;
receive, by the reading engine, a selection of a first narrative option of the two or more narrative options; and
generate, by the reading engine, a second chapter of the narrative based on the first narrative option, wherein:
the second chapter comprises a second set of challenge words, the second set of challenge words comprises the one or more low fluency words; and
the second chapter of the narrative is coherent with the first chapter of the narrative.

2. The system of claim 1, wherein the program instructions to generate, by the reading engine, the second chapter of the narrative cause, when executed by the one or more processors, to further direct the computing system to:
provide continuity information for the second chapter of the narrative to a content generator, wherein the continuity information comprises:
information on first chapter of the narrative; and
the one or more low fluency words; and
transmit, to the content generator, a request to generate the second chapter of the narrative based on the continuity information and the first narrative option; and
receive, from the content generator, the second chapter of the narrative.

3. The system of claim 1, wherein the program instructions to generate, by the reading engine, the first chapter of the narrative based on the first client device cause, when executed by the one or more processors, to further direct the computing system to:
determine, by the reading engine, user-based information associated with the first client device;
determine, by the reading engine, a first set of challenge words based on the user-based information; and
generate, by a content generator of the reading engine, the first chapter of the narrative based on the user-based information and the first set of challenge words.

4. The system of claim 1, wherein the program instructions further direct the computing system to:
generate, by a content generator of the reading engine, a cover image for the second chapter based on the first narrative option, wherein the cover image for the second chapter comprises one or more elements related to the first narrative option.

5. The system of claim 1, wherein the program instructions further direct the computing system to:
provide, by the reading engine, two or more additional narrative options for continuing the narrative present in the second chapter;
receive, by the reading engine, a selection of a second narrative option of the two or more additional narrative options; and
generate, by the reading engine, a third chapter of the narrative based on the second narrative option, wherein the third chapter of the narrative is coherent with the second chapter of the narrative.

6. The system of claim 1, wherein the program instructions to determine, by the reading engine, the one or more low fluency words based on the reading of the first client device cause, when executed by the one or more processors, to further direct the computing system to:
identify, by a pronunciation function of the reading engine, within the reading of the first chapter of the narrative one or more of:
a mispronunciation;
a repetition;
an insertion; or
an omission.

7. A method comprising:
receiving, from a first client device, an indication to start a narrative;
generating, by a reading engine, a first chapter of the narrative based on the first client device, wherein the first chapter comprises a first set of challenge words;
monitoring, by the reading engine, a reading of the first chapter by the first client device;
determining, by the reading engine, one or more low fluency words based on the reading of the first client device;
providing, by the reading engine, two or more narrative options for continuing the narrative present in the first chapter;
receiving, by the reading engine, a selection of a first narrative option of the two or more narrative options; and
generating, by the reading engine, a second chapter of the narrative based on the first narrative option, wherein:
the second chapter comprises a second set of challenge words, the second set of challenge words comprises the one or more low fluency words; and
the second chapter of the narrative is coherent with the first chapter of the narrative.

8. The method of claim 7, wherein:
monitoring, by the reading engine, the reading of the first chapter by the first client device further comprises receiving, by the reading engine, an audio stream from the first client device of a user of the first client device reading the first chapter; and
determining, by the reading engine, one or more low fluency words based on the reading of the first client device further comprises identifying, by the reading engine, one or more low fluency words based on audio within the audio stream.

9. The method of claim 7, the method further comprising:
determining, by the reading engine, one or more additional low fluency words based on a reading of second chapter from the first client device;
providing, by the reading engine, two or more additional narrative options for continuing the narrative present in the second chapter;
receiving, by the reading engine, a selection of a second narrative option of the two or more additional narrative options; and
generating, by the reading engine, a third chapter of the narrative based on the second narrative option, wherein:
the third chapter comprises a third set of challenge words, the third set of challenge words comprising the one or more additional low fluency words; and
the third chapter of the narrative is coherent with the second chapter of the narrative.

10. The method of claim 7, wherein generating, by the reading engine, the second chapter of the narrative comprises:
providing, to a content generator, continuity information for the second chapter of the narrative, wherein the continuity information comprises:
information on first chapter of the narrative; and
the one or more low fluency words; and
generating, by the content generator, the second chapter of the narrative based on the continuity information and the first narrative option.

11. The method of claim 7, the method further comprising:
generating, by a content generator of the reading engine, a cover image for the second chapter based on the first narrative option.

12. The method of claim 7, the method further comprising:
determining, by the reading engine, one or more related words based on the low fluency words; and
generating, by the reading engine, the second chapter of the narrative to include the one or more related words.

13. The method of claim 7, the method further comprising:
submitting, by the reading engine, the second chapter of the narrative to a quality assurance engine;
validating, by the quality assurance function, one or more quality parameters for the second chapter of the narrative; and
generating, by the quality assurance function, a quality score for the second chapter of the narrative based on the one or more quality parameters.

14. The method of claim 7, the method further comprising:
submitting, by the reading engine, the first chapter and the second chapter of the narrative to a coherency inspector; and
generating, by the coherency inspector, a coherency score for the first chapter and the second chapter of the narrative.

15. A computer readable storage media comprising processor-executable instructions configured to cause one or more processors to:
receive, from a first client device, an indication to start a narrative;
generate, by a reading engine, a first chapter of the narrative based on the first client device, wherein the first chapter comprises a first set of challenge words;
monitor, by the reading engine, a reading of the first chapter by the first client device;
determine, by the reading engine, one or more low fluency words based on the reading of the first client device;
provide, by the reading engine, two or more narrative options for continuing the narrative present in the first chapter;
receive, by the reading engine, a selection of a first narrative option of the two or more narrative options; and
generate, by the reading engine, a second chapter of the narrative based on the first narrative option, wherein:
the second chapter comprises a second set of challenge words, the second set of challenge words comprises the one or more low fluency words; and
the second chapter of the narrative is coherent with the first chapter of the narrative.

16. The computer readable storage media of claim 15, wherein the processor-executable instructions to generate, by the reading engine, the first chapter of the narrative based on the first client device cause the one or more processors to further execute processor-executable instructions stored in the computer readable storage media to:
determine, by the reading engine, user-based information associated with the first client device;
determine, by the reading engine, a first set of challenge words based on the user-based information; and
generate, by a content generator of the reading engine, the first chapter of the narrative based on the user-based information and the first set of challenge words.

17. The computer readable storage media of claim 15, wherein the processor-executable instructions cause the one or more processors to further execute processor-executable instructions stored in the computer readable storage media to:
generate, by a content generator of the reading engine, a cover image for the second chapter based on the first narrative option and the one or more fluency words, wherein the cover image for the second chapter comprises one or more elements related to the first narrative option and the one or more fluency words.

18. The computer readable storage media of claim 15, wherein the processor-executable instructions cause the one or more processors to further execute processor-executable instructions stored in the computer readable storage media to:
generate, by the reading engine, a title for the second chapter of the narrative, wherein the title of the chapter corresponds to the first narrative option.

19. The computer readable storage media of claim 15, wherein the processor-executable instructions cause the one or more processors to further execute processor-executable instructions stored in the computer readable storage media to:
submit, by the reading engine, the second chapter of the narrative to a quality assurance engine;
validate, by the quality assurance function, one or more quality parameters for the second chapter of the narrative; and
generate, by the quality assurance function, a quality score for second chapter of the narrative based on the one or more quality parameters.

20. The computer readable storage media of claim 15, wherein the processor-executable instructions cause the one or more processors to further execute processor-executable instructions stored in the computer readable storage media to:
determine, by the reading engine, one or more related words based on the low fluency words; and
generate, by the reading engine, the second chapter of the narrative to include the one or more related words.
